(19) United States
(12) Patent Application Publication
(10) Pub. No.: US 2026/0104262 A1
(43) Pub. Date: Apr. 16, 2026

(54) PASSAGEWAY DRIVING ASSISTANCE SYSTEM AND METHOD

(71) Applicant: GM Global Technology Operations LLC, Detroit, MI (US)

(72) Inventors: Alaa M. Khamis, Courtice, ON (CA); Yun Qian Miao, Waterloo, ON (CA); Mohammad Naserian, Windsor, ON (CA)

(73) Assignee: GM GLOBAL TECHNOLOGY OPERATIONS LLC, Detroit, MI (US)

(21) Appl. No.: 18/911,432

(22) Filed: Oct. 10, 2024

(51) Int. Cl. G01C 21/34

(52) U.S. Cl. CPC G01C 21/3461

(57) ABSTRACT

A driving assistance method for a vehicle having a rear-facing camera and pulling a trailer includes, through one or more controllers, identifying one or more geometric characteristics of the trailer using one or more images of the trailer taken from the rear-facing camera. The method also includes identifying one or more geometric characteristics of a passageway through which the vehicle and trailer intend to pass. Additionally, the method includes predicting based on the one or more geometric characteristics of the trailer and the one or more geometric characteristics of the passageway whether the passageway will physically interfere with the trailer. Further, the method includes, if the passageway is predicted to physically interfere with the trailer, taking action to prevent the interference.

### INTRODUCTION

This disclosure is in the field of systems and methods for providing driving assistance to vehicles passing through passageways.

A vehicle may pull a trailer or may carry a load in, for instance, a bed of the vehicle. In driving through a passageway, such as through a tunnel, under a bridge, or through other passageways that may have limited clearance, a system that will help assure that the vehicle has sufficient clearance to pass through the passageway will be beneficial.

### SUMMARY

A driving assistance method for a vehicle having a rear-facing camera and pulling a trailer includes, through one or more controllers, identifying one or more geometric characteristics of the trailer using one or more images of the trailer taken from the rear-facing camera. The method also includes identifying one or more geometric characteristics of a passageway through which the vehicle and trailer intend to pass. Additionally, the method includes predicting based on the one or more geometric characteristics of the trailer and the one or more geometric characteristics of the passageway whether the passageway will physically interfere with the trailer. Further, the method includes if the passageway is predicted to physically interfere with the trailer, taking action to prevent the interference.

The method may further include calculating a driving route for the vehicle, and the action to prevent the interference may include calculating an alternative driving route for the vehicle that does not include the passageway. The vehicle may be driven by a human driver, and the action to prevent the interference may include warning the driver about the interference.

The method may alternatively or additionally include using the rear-facing camera to identify a logo on the trailer, and identifying one or more geometric characteristics of the trailer may include retrieving the geometric characteristics from a database accessed via identification of the logo by the rear-facing camera.

Identifying one or more geometric characteristics of the passageway may include using one or more sensors included onboard the vehicle. Alternatively or additionally, identifying one or more geometric characteristics of the passageway may include using data about the passageway electronically communicated to the vehicle.

Identifying one or more geometric characteristics of the trailer may include instructing a driver of the vehicle to drive the vehicle in order to manipulate the trailer into a plurality of orientations relative to the rear-facing camera and using images of the trailer taken by the rear-facing camera with the trailer in the plurality of orientations.

A driving assistance method for a vehicle carrying a load or pulling a trailer carrying the load includes, through one or more controllers, identifying one or more geometric characteristics of the load; identifying one or more geometric characteristics of a passageway through which the vehicle intends to pass; predicting based on the one or more geometric characteristics of the load and the one or more geometric characteristics of the passageway whether the passageway will physically interfere with the load; and if the passageway is predicted to physically interfere with the load, take action to prevent the interference.

The driving assistance method may additionally include calculating a driving route for the vehicle, and the action to prevent the interference may include calculating an alternative driving route for the vehicle that does not include the passageway. Additionally or alternatively, the vehicle may be driven by a human driver, and the action to prevent the interference may include warning the driver about the interference.

The vehicle may have a rear-facing camera, and identifying one or more geometric characteristics of the load includes using one or more images of the load taken by the rear-facing camera to identify the one or more geometric characteristics of the load. Identifying one or more geometric characteristics of the load may include detecting shifting of the load.

Identifying one or more geometric characteristics of the passageway may include using one or more sensors included onboard the vehicle. Additionally or alternatively, identifying one or more geometric characteristics of the passageway may include using data about the passageway electronically communicated to the vehicle.

A vehicle has a front and a rear and pulls a trailer attached to the rear of the vehicle, and vehicle includes a rear-facing camera. Additionally, the vehicle contains one or more controllers collectively programmed with and operable to execute the following instructions: instruct a driver of the vehicle to drive the vehicle in order to manipulate the trailer into a plurality of orientations relative to the rear-facing camera; capture images of the trailer in the plurality of orientations with the rear-facing camera; use the images to identify one or more geometric characteristics of the trailer; identify one or more geometric characteristics of a passageway through which the vehicle and trailer intend to pass; predict based on the one or more geometric characteristics of the trailer and the one or more geometric characteristics of the passageway whether the passageway will physically interfere with the trailer; and if the passageway is predicted to physically interfere with the trailer, take action to prevent the interference.

The one or more controllers may be further programmed with and operable to execute an instruction to calculate a driving route for the vehicle, and the action to prevent the interference may include calculating an alternative driving route for the vehicle that does not include the passageway.

The vehicle may further include a front-facing camera. The one or more controllers may be collectively programmed with and operable to execute the following instructions: take one or more images of the passageway using the front-facing camera; use the one or more images to identify one or more reference points on a boundary of the passageway; and use the one or more reference points to identify a geometric characteristic of the passageway.

In the vehicle, the one or more controllers may be further collectively programmed with and operable to execute the following instruction: after identifying the one or more reference points on the boundary of the passageway, track the one or more reference points relative to motion of the vehicle in order to identify three-dimensional coordinates of the one or more reference points.

The geometric characteristic of the passageway may be a height of the passageway or of an opening thereof. The geometric characteristic of the passageway may be a curvature of an opening of the passageway.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 is an image of a vehicle and a trailer towed by the vehicle.

FIG. 2 is a driving assistance method and system.

FIG. 3 illustrates a methodology used in profiling a trailer or a load carried by the trailer.

FIG. 4 illustrates a Cold Start routine for profiling a trailer.

FIG. 5 illustrates a Hot Start routine for profiling a trailer.

FIG. 6 illustrates a tracking routine for a trailer.

FIG. 7 illustrates a process for profiling a passageway such as a tunnel.

FIG. 8 illustrates an additional process for profiling a passageway such as a tunnel or a roadway under a bridge.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

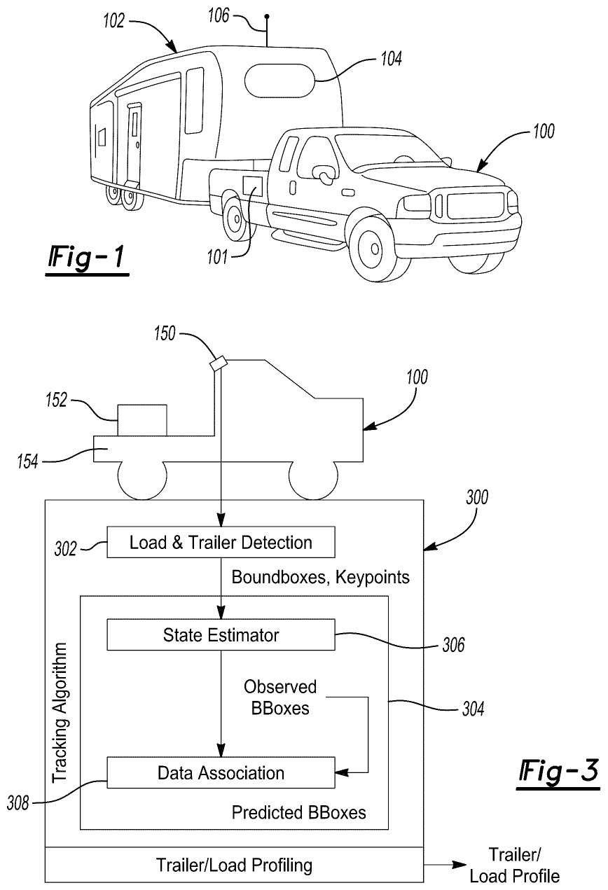

Referring to FIG. 1, a vehicle 100 is shown towing a trailer 102 that is coupled to vehicle 100. Trailer 102 may have a distinctive marking 104, such as a logo, trademark, trim level identifier, distinctive design, or color gradient through which the specific manufacturer, make, and/or model of trailer 102 may be visually identified.

Vehicle 100 has a rear-facing camera (not shown in FIG. 1 but that will hereinafter be illustrated and described) that can capture visual images of trailer 102, including distinctive marking 104. Trailer 102 may have an antenna 106 or other protrusions from, for example, the roof or a side of trailer 102.

Vehicle 100 may be any style of vehicle, such as a car, truck, van, sport-utility vehicle, or bus. Vehicle 100 may be an internal combustion engine vehicle, a battery-electric vehicle, or a hybrid vehicle whose propulsion is derived partly from batteries carried on board vehicle 100 and by an engine installed in vehicle 100.

Vehicle 100 may have an electronic controller 101. Electronic controller 101 may be programmed to perform the actions described in this disclosure. Electronic controller 101 should be understood to have sufficient electronic resources (e.g., microcontroller, memory, software, inputs, outputs, and the like) to perform the functions described herein. The functions described in this disclosure may also be performed by more than one electronic controller; those controllers may share data and computing responsibility, such as by being networked together.

The one or more controllers such as electronic controller 101 may be programmed or designed to carry out or execute instructions. Each instruction may further include or consist of one or more further instructions.

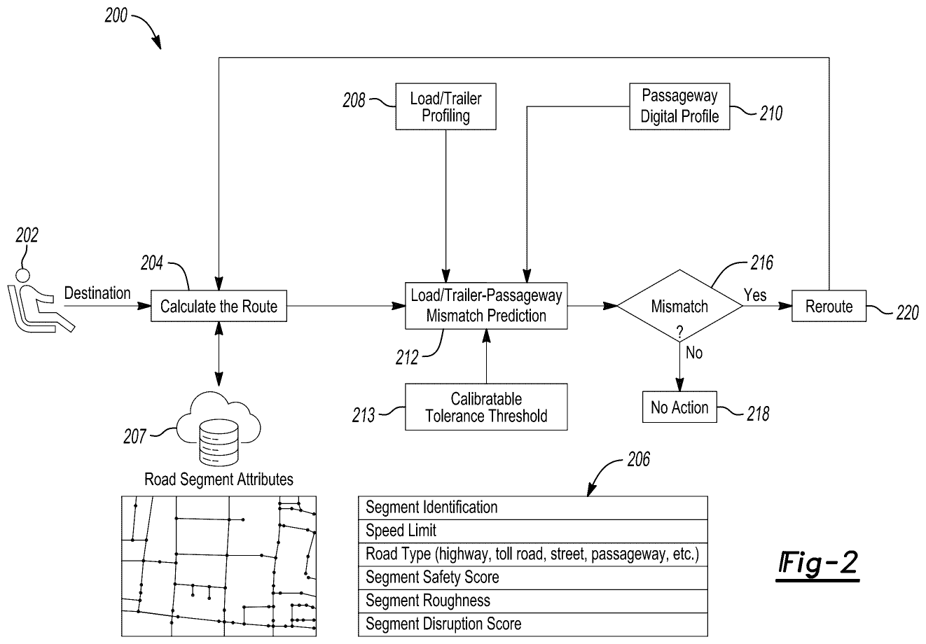

Refer now to FIG. 2. FIG. 2 illustrates a driving assistance method and system 200 adapted to prevent interference between trailer 102 and passageways through which vehicle 100 and trailer 102 may pass. Driving assistance system 200 may also or alternatively be adapted to prevent interference between a load carried in a bed of vehicle 100 or in a trailer (such as an open trailer) towed by vehicle 100 and passageways through which vehicle 100 may pass.

Vehicle 100 may have a human driver 202. Alternatively, vehicle 100 may be a self-guided vehicle with an automated driver. If vehicle 100 has a human driver 202, human driver 202 may input the desired (that is, intended) destination of vehicle 100 into the system. At block 204, the system may then calculate a driving route from the current location of vehicle 100 to the desired destination. The route may be calculated with the aid of knowledge of road segment attributes 206, which may be used to select an attractive intended route for vehicle 100. Road segment attributes 206 may be retrieved from a database 207 having knowledge of such road segment attributes 206. Database 207 may be included in media carried in a controller, such as electronic controller 101 in vehicle 100, or may be accessed wirelessly by electronic communication by electronic controller 101 or other electronic controllers in vehicle 100. Using road segment attributes 206 may assist in determining a favorable route for vehicle 100, especially if vehicle 100 is towing a trailer 102. Road segment attributes 206 may include the following:
Identification of the segment, such as by a unique identifier
The posted speed limit of the segment
The road type (divided highway, toll road, street, passageway, etc.)
A safety score for the segment based on historic data
Roughness of the segment
A disruption score for the segment (e.g., how often is the road segment closed or travel inhibited)

At block 208, the trailer 102 or the load carried by the vehicle 100 and/or by trailer 102 is profiled. Such profiling may include one or more geometric characteristics of trailer 102, including its cross-sectional profile; such profile may include a height and a width of trailer 102. The profiling may also include geometric characteristics of protrusions from trailer 102, such as antenna 106, and may include the length, width, and/or height of such protrusions. The protrusions may be relevant in determining limitations of passageways through which trailer 102 may pass. To the extent that vehicle 100 or trailer 102 carries a load, block 208 may also profile the load. Such profiling may include the physical size of the load, the extent to which the load projects outside the sides of vehicle 100 or trailer 102 and detecting the extent to which the load may have shifted during driving.

At block 210, a profile of an upcoming passageway along the route of vehicle 100 is retrieved. The profile of the passageway may be retrieved from a database containing attributes of the passageway, the attributes passed to block 212. Alternatively, attributes of the passageway may be identified by observation as vehicle 100 approaches the passageway, or by other methods that will be further described hereinafter.

At block 212, a comparison is made between the one or more geometric characteristics of trailer 102 or the load, on the one hand, and the profile of the passageway on the other hand; such profile may include geometric information about the boundaries of the passageway. That comparison may be by way of a calibratable tolerance threshold 213, to help assure clearance from the passageway with a suitable margin for error. The comparison may generate a prediction of whether trailer 102 or the load will interfere (that is, whether there will be a mismatch) with the boundaries (e.g., the walls) of the passageway and/or the entrance to the passageway. If there is no mismatch, decision block 216 will cause no action to be taken (block 218). If there is a mismatch, however, the vehicle may be rerouted (block 220) through calculation of an alternative driving route to a route that avoids the passageway with which trailer 102 or the load would interfere.

Refer now to FIG. 3, where a profiling block 300 for trailer 102 or load 152 is illustrated. Input for profiling of trailer 102 or load 152 may come from a rear-facing camera 150. Camera 150 may be a so-called “CHMSL” camera, that is, a camera that is mounted near the center high-mounted stop lamp (“CHMSL”) of vehicle 100. Camera 150 may be a monocular RGB (red-green-blue) color camera.

The image from camera 150 may be fed to block 302, a load/trailer detection block. This detection may be performed, for instance, using the so-called YOLO (You Only Look Once) object detection algorithm, which is a real-time object detection algorithm. The outputs of block 302 are boundboxes and keypoints. Next, the data is provided to a tracking algorithm 304. Tracking algorithm 304 may be a so-called SORT (Simple Online and Realtime Tracking) algorithm that includes a state estimator 306 such as a linear Kalman filter and data association 308 that may use the so-called Hungarian method, which uses intersection-over-union (IOU) distance. The output is predicted boundary boxes for trailer 102 and/or load 152. The profile for trailer 102 and/or load 152, which may include the geometric extents (height and width, for instance) thereof, is an output of block 302.

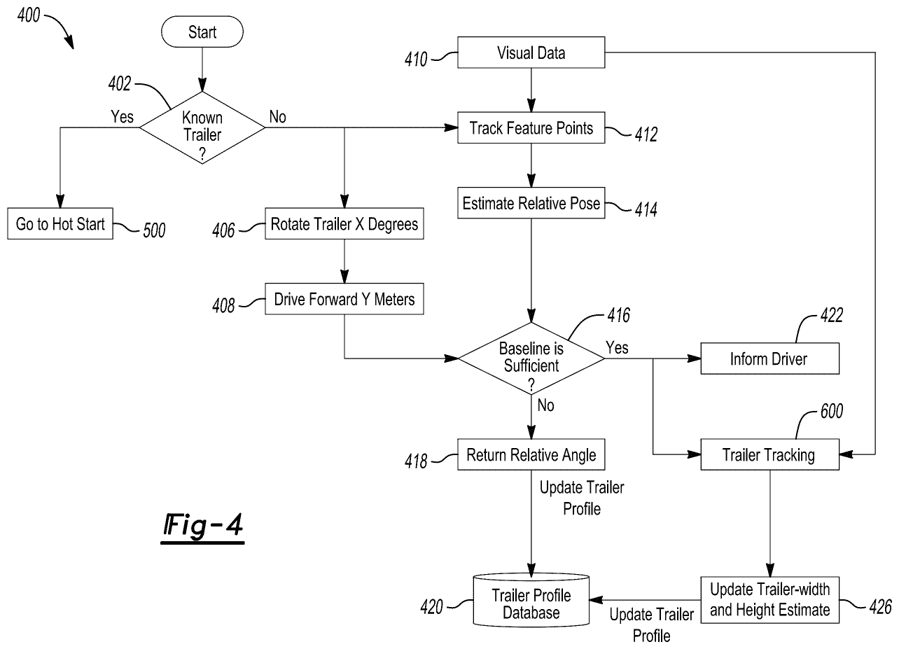

Refer now to FIG. 4. Illustrated there is a “cold start” algorithm 400 in the event that detection of trailer 102 begins fresh (that is, from cold start). At block 402, it is determined whether trailer 102 is a “known” trailer; trailer 102 and its geometry may be “known” from having been previously detected by vehicle 100. Trailer 102 may also be known from being in a database accessible to vehicle 100, such as through wireless electronic communication with an offboard server; identification of distinctive marking 104 by camera 150 may identify trailer 102, whose attributes may be available in the database. If trailer 102 is known, the algorithm proceeds to execute a “hot start” at block 500. The hot start algorithm will be further explained hereinafter.

If trailer 102 is not known, actions may be taken to characterize trailer 102. At block 406, the driver may be instructed by the system to drive so as to rotate trailer 102 by a certain amount (say, “X” degrees) and, at block 408, to drive forward by a certain distance (say, “Y” degrees). This manipulation of trailer 102 into a plurality of orientations relative to camera 150 may provide camera 150, which may be a monocular camera, with enough visual frames and sufficient perspective to understand the geometric profile of trailer 102; a significant element of the geometric profile of trailer 102 may be the cross-sectional profile (including width and height) of trailer 102. The profile may also include dimensions of protrusions (e.g., the height of antenna 106) from trailer 102.

At block 410, visual data from camera 150 may be evaluated, including tracking reference feature points of trailer 102 (block 412) and estimating the relative pose (block 414) thereof; the relative pose may include the position and orientation of the reference feature points. At block 416, it is determined whether the baseline is sufficient, that is, whether enough reference frames have been gathered to build a profile of trailer 102. If not, the relative angle of trailer 102 is returned at block 418; the relative angle here between trailer 102 and vehicle 100 may be estimated, relative to ground reference, if no trailer hitch rotation sensor is available. The trailer profile database 420 is then updated.

If the result of block 416 is that the baseline is wide enough, the driver of the vehicle may be informed at block 422 through a suitable HMI (human machine interface) mechanism provided in vehicle 100. Trailer tracking (block 600) may also be initiated, which will be described in more detail hereinafter; trailer tracking (block 600) may also use visual data from block 410. At block 426, after trailer tracking (block 600), the width and height estimates of trailer 102 are updated and the trailer profile database 420 is updated.

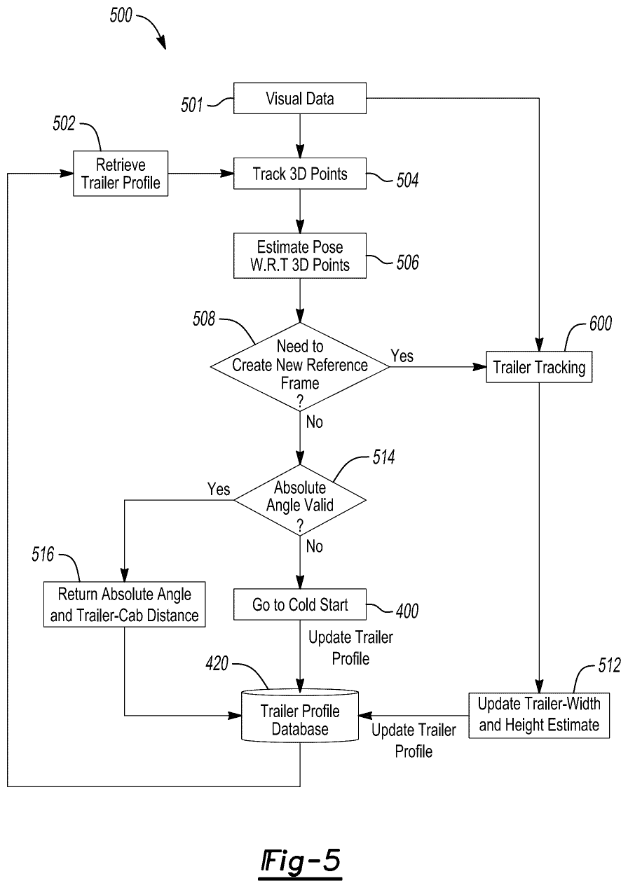

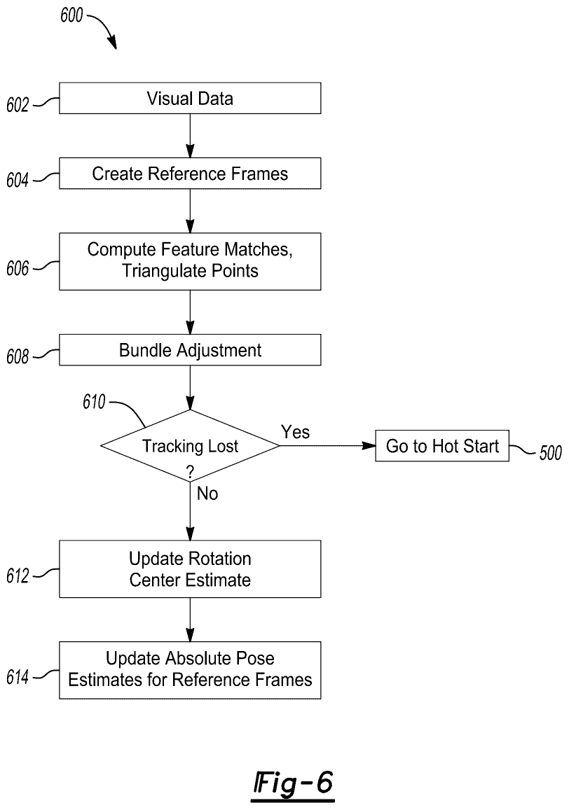

A hot start algorithm (such as block 500 of FIG. 4) is illustrated in detail with reference to FIG. 5. At block 501, visual data from camera 150 is retrieved, as is the profile of trailer 102 (block 502) from the trailer profile database 420. Three-dimensional points (which may be a three-dimensional point cloud) of trailer 102 are tracked at block 504, and the pose of trailer 102 is estimated with respect to the three-dimensional points at block 506. At block 508, it is determined whether a new reference frame needs to be created if, for instance, a reference frame is “dropped” or lost for any reason. If yes, the algorithm proceeds to trailer tracking (block 600), where estimates of the width and height of trailer 102 may be updated (block 512). The trailer profile database 420 may then be updated with an updated profile of trailer 102.

If the answer at block 508 is no, at block 514 it is determined whether the absolute angle of trailer 102 is valid. This may be judged with respect to rotational boundary constraints (e.g., trailer 102 may only physically be rotated within a certain angular range), or rotational rate constraints (that is, trailer 102 may only physically rotate at up to a maximum angular rate). If yes, the absolute angle and the distance from trailer 102 to camera 150 (at the back of the cab of vehicle 100) are returned (block 516) to the trailer profile database 420. If at block 514 the absolute angle is not valid, the algorithm goes to cold start (block 400 and FIG. 4). Thereafter, trailer profile database 420 may be updated.

Trailer tracking 600 is illustrated with respect to FIG. 6. At block 602, visual data from camera 150 is accessed. At block 604, reference frames from the visual data are created. At block 606, feature matches are computed and reference points triangulated. Features being matched may include distinctive marking 104. At block 608, a so-called bundle adjustment occurs, a machine vision processing technique to enhance the accuracy and reliability of 3D scene reconstructions from multiple images and camera views. At block 610, it is determined whether tracking of trailer 102 has been lost. If yes, the algorithm progresses to hot start (block 500 and FIG. 5). If tracking has not been lost, the rotation center estimate is updated at block 612 and absolute pose estimates for reference frames are updated at block 614, where width and height of trailer 102 may be estimated.

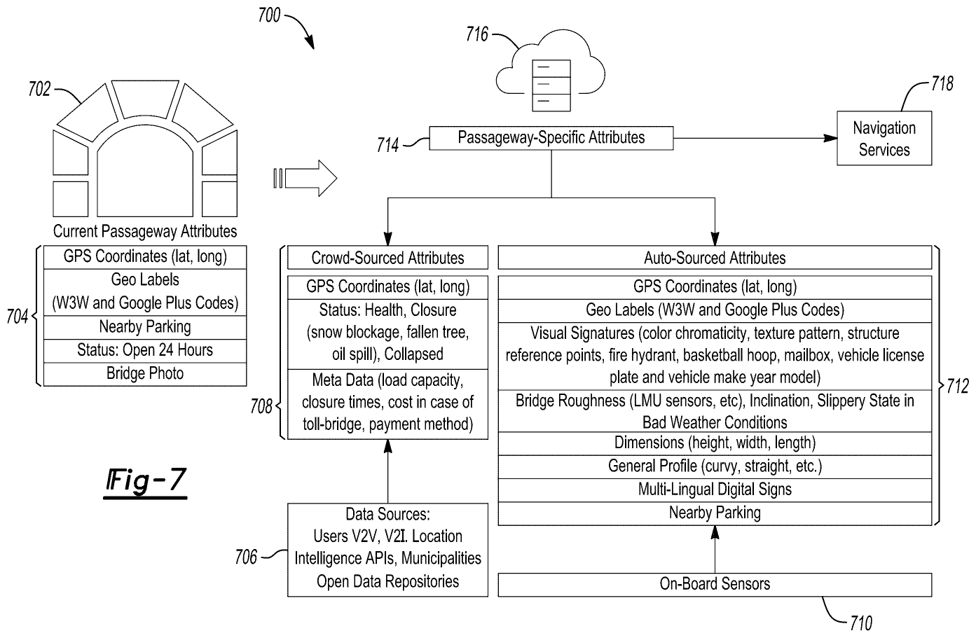

FIG. 7 illustrates a process 700 for performing digital profiling of a passageway 702 such as a tunnel. Passageway 702 may also be a bridge or any other passageway having a limited width or height and for which avoiding interfering with trailer 102 or load 152 is desirable.

Passageway 702 may have certain publicly-available and generally-non-time variant attributes that may be provided by e.g., the respective Department of Transportation of other agency. Those may include those in block 704, such as:
Global Positioning Satellite (“GPS”) latitude and longitude coordinates
Geographic labels (e.g., What 3 Words (“W3W”) or Google Plus codes
Location and availability of nearby parking
Open/closed hours of the passageway (e.g., open 24 hours)
A photographic image of the passageway (e.g., bridge or tunnel)

Passageway 702 may have other attributes that may be crowd sourced via crowd-sourced data sources 706. Those data sources may include V2V (vehicle-to-vehicle) information provided wirelessly by electronic communication by other vehicles, V2I (vehicle-to-infrastructure) information provided wirelessly by electronic communication by infrastructure, location intelligence APIs (application programming interfaces) and municipality open data repositories.

The crowd-sourced attributes may include those listed in block 708, such as:
GPS coordinates of the passageway (e.g., latitude and longitude)
Status of the passageway, e.g., health (state of repair of the passageway), closure status (e.g., because of snow blockage, a fallen tree, or an oil spill)
Whether the passageway has collapsed
Metadata such as load capacity, closure times, cost and accepted payment methods (in the case of a toll bridge or tunnel)

Passageway 702 may have additional attributes that may be “auto-sourced” by vehicle 100 itself. That may come via on-board data from sensors (block 710) onboard vehicle 100. The auto-sourced data may include the items listed in block 712, such as:
GPS coordinates of the passageway (e.g., latitude and longitude)
Geographic labels (e.g., W3W or Google Plus codes)
Visual signatures through which the passageway may be identified (e.g., color chromaticity, texture pattern, reference points on the structure, existence and/or location of fire hydrants, basketball hoops, mailboxes, vehicle license plates and vehicle make/year/model of vehicles that may be frequently parked near the passageway)
Roughness of the bridge or roadway, as gauged by vehicle Inertial Motion Unit (“IMU”) data from an IMU onboard vehicle 100, as well as inclination of the roadway and slipperiness state of the roadway
Dimensions of the passageway (height, width, length)
General profile of the passageway (curved, straight, etc.)
The existence of multi-lingual digital signage
Location and availability of nearby parking

The passageway specific attributes 714 (e.g., those in block 708 and block 712) may be provided to a database 716 and included with a unique digital identifier for the specific passageway. That data would then be available for future reference regarding the specific passageway. The data may also be provided to various mapping, route planning and navigation services (block 718) (e.g., OnStar and GM Future Roads, each operated by General Motors Company) for additional or future use.

The additional characteristics of the passageway beyond the geometry thereof may also be used for the purpose of rerouting vehicle 100. For instance, if it becomes understood that a passageway on the intended route of vehicle 100 is closed (e.g., due to regularly-scheduled closure, construction, unscheduled closures, or the like), vehicle 100 may be rerouted to an alternative route to the intended destination of vehicle 100. The location of the passageway on the intended route is known from GPS data, through any of block 704, block 708, or block 712.

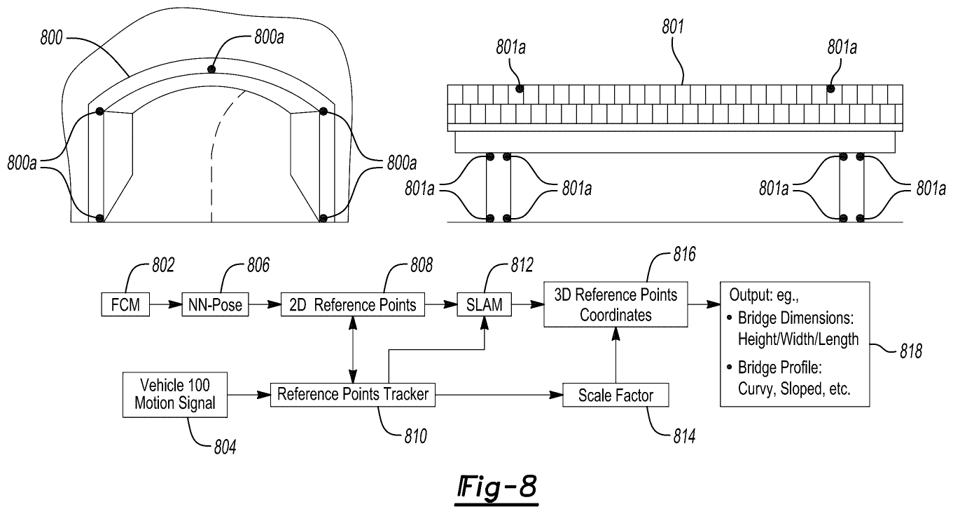

One particular use of data from onboard sensors (block 710) of vehicle 100 is illustrated with reference to FIG. 8. Here, vehicle 100 may be approaching a tunnel 800 or a bridge 801. Data from a front camera module (“FCM”) 802 in vehicle 100 may be used, along with a motion signal 804 from vehicle 100. The data from FCM 802 may be provided to a neural network 806. Two-dimensional reference points 800a at the entry to tunnel 800 or two-dimensional reference points 801a on bridge 801 may be selected (block 808) and may be tracked (block 810) with reference to the motion of vehicle 100. So-called Simultaneous Localization and Mapping (“SLAM”) 812 analysis may be performed and scale factor 814 applied based on an understanding of the motion of vehicle 100. Three-dimensional coordinates 816 of the reference points may be derived, with the outputs 818 including the dimensions of the tunnel 800 or bridge 801 passageways, as well as the profile of the passageways (e.g., the curvature or slope of the entrance to tunnel 800 or passageway under bridge 801).

Load 152 (FIG. 3) may include items that may extend outside bed 154 of vehicle 100, including beyond the width of vehicle 100. Such items may include, for instance, lumber such as 2×4s. It is desirable to understand if and the extent to which those items may extend outside bed 154 of vehicle 100, including outside bed 154 and beyond the width of vehicle 100, as that may pose an issue of interference with a passageway (e.g., tunnel 800 or the roadway under bridge 801) through which vehicle 100 may pass. Here, camera 150 may capture images of the load 152 and bed 154. Having very complete knowledge of the length and width of bed 154 and its distance from camera 150 (given that bed 154 was designed by the same company that designed the rest of vehicle 100), the extent to which load 152 extends outside bed 154 can be determined via geometry. That may be used, consistently with the remainder of this disclosure, in order to predict interference between load 152 and a passageway through which vehicle 100 may be planning to pass and providing a warning or rerouting vehicle 100 to a different route that avoids the particular passageway.

Load 152 may shift during driving of vehicle 100. As a means for providing information about the shifting of load 152 in order to identify how the profile of load 152 may have changed and may have therefore potentially created an interference condition with a passageway through which vehicle 100 may be intending to pass, the method of published commonly-assigned U.S. patent application Ser. No. 17/973,763 of General Motors LLC may be employed; the disclosure of that patent publication is hereby incorporated by reference in its entirety in this disclosure.

FCM 802 may also read traffic signage using appropriate text-recognition technology. That signage may, for instance, indicate the height clearance of a tunnel or bridge; that information may assist with profiling the tunnel or bridge. The signage may also indicate when a tunnel coming up on the intended route of vehicle 100 is closed, such as due to a disabled vehicle in the roadway, a weather incident such as snow, or normal scheduled closure of the tunnel. That information may be used to reroute vehicle 100 to an alternative route that does not include the specific bridge or tunnel.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure.

Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims. Moreover, this disclosure expressly includes combinations and sub-combinations of the elements and features presented above and below.

What is claimed is:

1. A driving assistance method for a vehicle having a rear-facing camera and pulling a trailer, the method comprising:
through one or more controllers:
identifying one or more geometric characteristics of the trailer using one or more images of the trailer taken from the rear-facing camera;
identifying one or more geometric characteristics of a passageway through which the vehicle and trailer intend to pass;
predicting based on the one or more geometric characteristics of the trailer and the one or more geometric characteristics of the passageway whether the passageway will physically interfere with the trailer; and
if the passageway is predicted to physically interfere with the trailer, taking action to prevent the interference.

2. The driving assistance method of claim 1, further comprising:
calculating a driving route for the vehicle;
wherein the action to prevent the interference includes calculating an alternative driving route for the vehicle that does not include the passageway.

3. The driving assistance method of claim 1, wherein:
the vehicle is driven by a human driver; and
the action to prevent the interference includes warning the human driver about the interference.

4. The driving assistance method of claim 1, wherein:
the method further includes using the rear-facing camera to identify a logo on the trailer; and
identifying one or more geometric characteristics of the trailer includes retrieving the geometric characteristics from a database accessed via identification of the logo by the rear-facing camera.

5. The driving assistance method of claim 1, wherein identifying one or more geometric characteristics of the passageway includes using one or more sensors included onboard the vehicle.

6. The driving assistance method of claim 1, wherein identifying one or more geometric characteristics of the passageway includes using data about the passageway electronically communicated to the vehicle.

7. The driving assistance method of claim 1, wherein identifying one or more geometric characteristics of the trailer includes:
instructing a driver of the vehicle to drive the vehicle in order to manipulate the trailer into a plurality of orientations relative to the rear-facing camera; and
using images of the trailer taken by the rear-facing camera with the trailer in the plurality of orientations.

8. A driving assistance method for a vehicle carrying a load or pulling a trailer carrying the load, the method comprising:
through one or more controllers:
identifying one or more geometric characteristics of the load;
identifying one or more geometric characteristics of a passageway through which the vehicle intends to pass;
predicting based on the one or more geometric characteristics of the load and the one or more geometric characteristics of the passageway whether the passageway will physically interfere with the load; and
if the passageway is predicted to physically interfere with the load, take action to prevent the interference.

9. The driving assistance method of claim 8, further comprising:
calculating a driving route for the vehicle;
wherein the action to prevent the interference includes calculating an alternative driving route for the vehicle that does not include the passageway.

10. The driving assistance method of claim 8, wherein:
the vehicle is driven by a human driver; and
the action to prevent the interference includes warning the driver about the interference.

11. The driving assistance method of claim 8, wherein:
the vehicle has a rear-facing camera; and
identifying one or more geometric characteristics of the load includes using one or more images of the load taken by the rear-facing camera to identify the one or more geometric characteristics of the load.

12. The driving assistance method of claim 11, wherein identifying one or more geometric characteristics of the load includes detecting shifting of the load.

13. The driving assistance method of claim 8, wherein identifying one or more geometric characteristics of the passageway includes using one or more sensors included onboard the vehicle.

14. The driving assistance method of claim 8, wherein identifying one or more geometric characteristics of the passageway includes using data about the passageway electronically communicated to the vehicle.

15. A vehicle having a front and a rear and pulling a trailer attached to the rear of the vehicle, the vehicle comprising:
a rear-facing camera;
one or more controllers collectively programmed with and operable to execute the following instructions:
instruct a driver of the vehicle to drive the vehicle in order to manipulate the trailer into a plurality of orientations relative to the rear-facing camera;
capture images of the trailer in the plurality of orientations with the rear-facing camera;
use the images to identify one or more geometric characteristics of the trailer;
identify one or more geometric characteristics of a passageway through which the vehicle and trailer intend to pass;
predict based on the one or more geometric characteristics of the trailer and the one or more geometric characteristics of the passageway whether the passageway will physically interfere with the trailer; and
if the passageway is predicted to physically interfere with the trailer, take action to prevent the interference.

16. The vehicle of claim 15, wherein:
the one or more controllers are further programmed with and operable to execute an instruction to calculate a driving route for the vehicle; and
the action to prevent the interference includes calculating an alternative driving route for the vehicle that does not include the passageway.

17. The vehicle of claim 15, wherein:
the vehicle further includes a front-facing camera; and
the one or more controllers are further collectively programmed with and operable to execute the following instructions:
take one or more images of the passageway using the front-facing camera;
use the one or more images to identify one or more reference points on a boundary of the passageway; and
use the one or more reference points to identify a geometric characteristic of the passageway.

18. The vehicle of claim 17, wherein the one or more controllers are further collectively programmed with and operable to execute the following instruction:
after identifying the one or more reference points on the boundary of the passageway, track the one or more reference points relative to motion of the vehicle in order to identify three-dimensional coordinates of the one or more reference points.

19. The vehicle of claim 18, wherein the geometric characteristic of the passageway is a height of the passageway or of an opening thereof.

20. The vehicle of claim 18, wherein the geometric characteristic of the passageway is a curvature of an opening of the passageway.
